(19) United States
(12) Patent Application Publication
(10) Pub. No.: US 2006/0239151 A1
(43) Pub. Date: Oct. 26, 2006

(54) OPTICAL DISC DRIVE SYSTEM FOR DATA RECORDING THAT DOES NOT NEED TO BE SYNCHRONIZED WITH DISC ROTATION AND METHOD THEREOF

(76) Inventors: Daw-I Wang, Taipei Hsien (TW); Chih-Long Dai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/428,544

(22) Filed: Jul. 3, 2006

Related U.S. Application Data
(63) Continuation-in-part of application No. 10/065,765, filed on Nov. 18, 2002.

(30) Foreign Application Priority Data
Jul. 25, 2002 (TW) 091116645

(51) Int. Cl. G11B 20/10

(52) U.S. Cl. 369/47.28

(57) ABSTRACT

An optical disc system for recording data includes an optical pickup unit for accessing data on the disc rotating at a constant angular velocity and producing a wobble signal; a spindle motor for rotating the disc according to a control signal; a circuit for generating the control signal according to a rotation speed of the spindle motor, the circuit not being coupled to the wobble signal; a phase locked loop for extracting a carrier frequency of the wobble signal; a clock synthesizer for producing a channel clock corresponding to a linear velocity, according to the wobble signal carrier frequency; an encoding unit for encoding incoming data utilizing the channel clock, and then for producing a corresponding data signal for driving the optical pickup unit to record data to the optical disc; whereby data recording does not need to be synchronized with the spindle motor operation.

### CROSS REFERENCE TO RELATED APPLICATIONS

This is a continuation-in-part of co-pending U.S. patent application Ser. No. 10/065,765, filed on Nov. 18, 2002, entitled “Optical Disc Drive System for recording at a Constant Angular Velocity”, the contents of which are incorporated herein by reference.

### BACKGROUND

The present invention relates to optical disc drive systems, and more particularly, to an optical disc drive system for recording data to an optical disc wherein data recording does not need to be synchronized with the disc rotation, and a method thereof.

Optical discs, as well as having the advantages of low cost, convenient size, and low weight, are able to store large quantities of data, and have already become the most common storage medium in today's modern information society. In particular, research and development of recordable optical discs has allowed users to record data to the optical discs at will, thereby further making optical discs one of the most important personal storage media of today. It is a goal of modern information industry research and development to increase the reliability and efficiency of recording information to the optical disc. Currently, speeds of optical disc recorders are increasing rapidly, and latest technology recorders are able to record at speeds 30-40 times faster than their original counterparts. At such high speeds, however, many problems arise.

In compact disc recordable (CD-R) and compact disc rewriteable (CD-RW) systems, data is recorded according to density. An amount of information written over each unit length must meet a certain specification. Up to the present, CD-R and CD-RW recorders have used a constant linear velocity (CLV) recording method, namely, controlling a spindle motor, which matches an optical pickup unit to the linear velocity of the optical disc, and then recording the data at a fixed frequency according to the linear velocity. Owing to the development of higher speed recorders, however, the maximum constant linear velocity is limited by the spindle motor.

Thus, current recording technology uses another, derived, constant linear velocity in order to achieve high-speed operation. This technology is called Zone-CLV. Zone-CLV divides the optical disc into zones, and each zone is assigned a specific linear velocity. The velocities increase from the center of the disc outward. Each time a boundary between zones is crossed, however, recording must be stopped, while the spindle motor changes speed, before data recording can continue. During this process, the spindle motor must be controlled very accurately, and this causes next-generation recording technology to become difficult to reach.

### SUMMARY

Thus, it is an objective of the claimed invention to provide an optical disc recording system where data recording is independent of a spindle motor, thereby easing control circuitry precision requirements.

Briefly, the claimed invention provides an optical disc system for recording data to an optical disc rotating at a constant angular velocity. The optical disc system comprises: an optical pickup unit for accessing data on the disc and producing a wobble signal; a spindle motor for rotating the disc according to a control signal; a circuit for generating the control signal according to a rotation speed of the spindle motor, the circuit not being coupled to the wobble signal; a phase locked loop (PLL) for extracting a carrier frequency of the wobble signal; a clock synthesizer for producing a channel clock corresponding to a linear velocity, according to the wobble signal carrier frequency; an encoding unit for encoding incoming data utilizing the channel clock, and then for producing a corresponding data signal for driving the optical pickup unit to record data to the optical disc; whereby data recording does not need to be synchronized with the spindle motor operation.

A method is further provided. The method comprises: providing an optical pickup unit for accessing a wobble signal from the optical disc; providing a spindle motor for rotating the optical disc according to a control signal; generating the control signal according to a rotation speed of the spindle motor and not according to the wobble signal; extracting a carrier frequency of the wobble signal; utilizing the wobble signal carrier frequency to generate a channel clock corresponding to a linear velocity; encoding incoming data utilizing the channel clock, and then producing a corresponding data signal for driving the optical pickup unit to record data to the optical disc; whereby data recording does not need to be synchronized with the spindle motor operation.

It is an advantage of the claimed invention that, because the spindle motor control is independent of the channel clock generation, data recording is independent of the spindle motor operation, and therefore precise control of the spindle motor is not required. In addition, the optical disc system also can obtain maximum recording efficiency as the spindle motor can constantly maintain maximum rotation speed.

These and other objectives of the present invention will no doubt become obvious to those of ordinary skill in the art after reading the following detailed description of the preferred embodiment that is illustrated in the various figures and drawings.

### BRIEF DESCRIPTION OF TE DRAWINGS

FIG. 1 is a diagram of an optical disc system according to an embodiment of the present invention.

### DETAILED DESCRIPTION

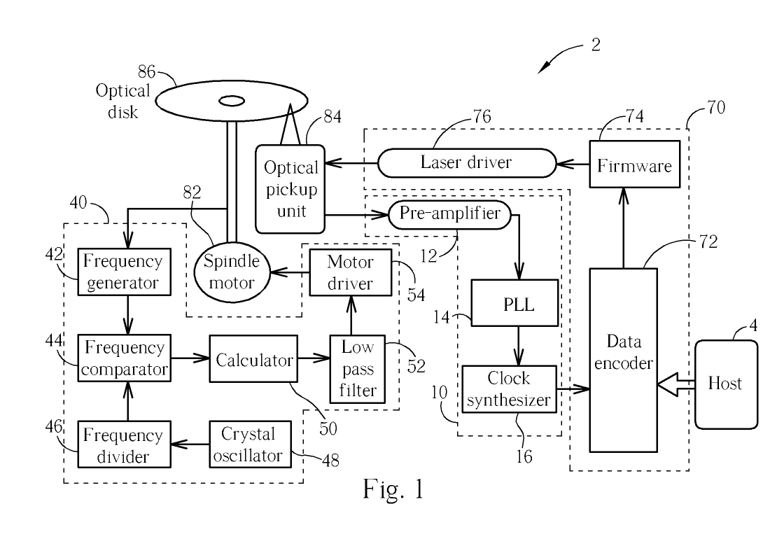

Please refer to FIG. 1, which is a diagram of an optical disc system 2 according to an embodiment of the present invention. The optical disc system 2 (e.g. an optical disc recorder) comprises a host 4, a first circuit 10, a second circuit 40, a third circuit 70, a spindle motor 82, and a laser optical pickup unit 84. The first circuit 10 is used for receiving a wobble signal from an optical disc 86, and using the wobble signal to generate a channel clock, which is sent to the third circuit 70. The third circuit 70 encodes data from the host 4 to a data form that can be recorded by the optical disc system 2. The second circuit 40 is used to drive the spindle motor 82 at a fixed frequency. It should be noted that the second circuit 40, in this embodiment, is not coupled to a wobble signal sent from the laser optical pickup unit 84. In other words, the operation of the second circuit 40 has no relation to the wobble signal. As can be seen from FIG. 1, the second circuit 40 is independent from the first circuit 10 and the third circuit 70.

The detailed data recording operation will be described herein. Please refer again to the third circuit 70 of FIG. 1. The third circuit 70 comprises the data encoder 72, a firmware 74, and a laser driver 76. The data encoder 70 electrically connected to the host 4 and the clock synthesizer 16 of the first circuit 10 constantly gets a latest channel clock from the clock synthesizer 16. Hence, the data encoder 72 is capable of constantly encoding the inputted data from the host 4 by the latest channel clock. Then, the encoded data transforms into a proper pulse train based on a write strategy stored in the firmware 74 to conduct the laser driver 76 to control the laser optical pickup unit 84 for recording to the optical disc 86.

Please refer again to the first circuit 10. The first circuit 10 comprises a pre-amplifier 12, a phase-locked loop (PLL) 14, and a clock synthesizer 16. The preamplifier 12 is used to amplify a wobble signal sent from the laser optical pickup unit 84 for further processing. The wobble signal is then immediately input to the PLL 14. The wobble signal is an Archimedes spiral, and is stored on an absolute time in pre-groove (ATIP) of the optical disc through frequency shift key (FSK) modulation. Thus, by sending the signal to the PLL 14, the carrier frequency of the wobble signal can be extracted. The frequency is given by 22.05*n KHz, where “n” represents a linear multiplier of the optical disc drive rotation, and need not be an integer. The data is sent to the clock synthesizer 16, so that the clock synthesizer 16 can produce a channel clock at 4.3218*n MHz, where “n” is the linear multiplier mentioned above. As described above, the channel clock is for use by the encoder 72 as a reference clock when performing data encoding. The channel clock is also key in calculating a constant angular velocity (CAV) in the present invention. Because the multiplier “n” of the CAV changes with the movement of the optical pickup unit 84, by constantly updating the channel clock, the system 2 can ensure that the data produced by the data encoder 72 is correct when being recorded to the optical disc. Furthermore, as the wobble signal is affected by the rotation of the optical disc, data recording can be accurately controlled without having to simultaneously control the movement of the spindle motor. If the disc rotation is unstable, e.g. due to the spindle motor operating at maximum rotation speed, the wobble signal will be affected. By constantly updating the channel clock according to the wobble signal, data encoding can be adjusted to compensate for the unstable movement of the spindle motor, and data can thus be recorded to the optical disc accurately.

As can be seen from FIG. 1, the second circuit 40, for controlling the spindle motor 82, is independent of the first circuit 10 and the third circuit 70. The spindle motor operation is therefore independent of the data recording operation. The spindle motor operation will be described herein. Please refer again to the second circuit 40 of FIG. 1. The second circuit 40 comprises a frequency generator 42, a frequency comparator 44, a frequency divider 46, a crystal oscillator 48, a motor driver circuit 54, a calculator 50, and a low-pass filter 52. The frequency generator 42 is electrically connected to the spindle motor 82 and produces six pulses for each turn of the motor 82. The frequency generator 42 produces a corresponding first signal with a change of rotation speed of the spindle motor 82. Meanwhile, the crystal oscillator 48 produces a fixed frequency and then sends the fixed frequency to the frequency divider 46 to produce a second signal where the frequency of the second signal is a frequency of an expected uniform rotation angular velocity. The first signal and the second signal are sent to the frequency comparator 44 for comparing, and the frequency comparator 44 sends the compared result to the calculator 50; the processed signal by the calculator 50 passes through the low-pass filter 52 for filtering the signal and then is sent to the motor driver circuit 54. The spindle motor 82 will be accelerated or decelerated by the motor driver circuit 54 according to the inputted signal. This inputted signal is a control signal for controlling the rotation of the spindle motor 82. This means that if the frequency of the second signal produced by the frequency divider 46, i.e. the predetermined frequency corresponding to the spindle motor 82, is higher than the frequency of the rotating spindle motor 82 at that time, the motor driver circuit 54 will accelerate the rotation speed of the spindle motor 82. If the frequency of the second signal produced by the frequency divider 46 is lower than the frequency of the rotating spindle motor 82 at that time, the motor driver circuit 54 will decelerate the rotation speed of the spindle motor 82.

While the optical disc system 2 is performing a data recording operation, because the first circuit 10 uses the wobble signal to constantly update a channel clock for data recording, the spindle motor 82 can be kept at a constant rotation speed, and does not need to be accelerated or decelerated according to the rotation radius, resulting in greatly reducing the precision required for controlling the spindle motor 82, which is a limitation of the constant-linear-velocity-operated spindle motor 82. As the circuit for producing the control signal and the circuit for producing the wobble signal are separate from each other, it can be clearly seen that a data recording operation is independent of the spindle motor operation. In addition, the optical disc system 2 can compensate for unstable motion of the spindle motor during data recording, by the use of the constantly updated channel clock.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical disc system for recording data to an optical disc, the optical disc system comprising:
an optical pickup unit for accessing data on the disc and producing a wobble signal;
a spindle motor for rotating the disc according to a control signal;
a circuit for generating the control signal according to a rotation speed of the spindle motor, the circuit not being coupled to the wobble signal;
a phase locked loop (PLL) for extracting a carrier frequency of the wobble signal;
a clock synthesizer for producing a channel clock corresponding to a linear velocity, according to the wobble signal carrier frequency; and
an encoding unit for encoding incoming data utilizing the channel clock, and then for producing a corresponding data signal for driving the optical pickup unit to record data to the optical disc;
whereby data recording does not need to be synchronized with the spindle motor operation.

2. The optical disc system of claim 1, further comprising a preamplifier connected between the optical pickup unit and the PLL for amplifying the wobble signal output by the optical pickup unit.

3. The optical disc system of claim 1, wherein the encoding unit further comprises:
a data encoder, for encoding data according to the channel clock;
a firmware, for transforming the encoded data into a pulse train; and
a laser driver, for controlling the optical pickup unit for recording to the optical disc.

4. The optical disc system of claim 1 wherein the optical pickup unit is a laser pickup.

5. The optical disc system of claim 1 being an optical disc recorder.

6. The optical disc system of claim 1, wherein the spindle motor rotates the optical disc at constant angular velocity.

7. A method for recording data to an optical disc, the method comprising:
providing an optical pickup unit for accessing a wobble signal from the optical disc;
providing a spindle motor for rotating the optical disc according to a control signal;
generating the control signal according to a rotation speed of the spindle motor and not according to the wobble signal;
extracting a carrier frequency of the wobble signal;
utilizing the wobble signal carrier frequency to generate a channel clock corresponding to a linear velocity; and
encoding incoming data utilizing the channel clock, and then producing a corresponding data signal for driving the optical pickup unit to record data to the optical disc;
whereby data recording does not need to be synchronized with the spindle motor operation.

8. The method of claim 7, wherein the step of accessing the wobble signal from the optical disc further comprises amplifying the wobble signal.

9. The method of claim 7 wherein the optical disc system is an optical disc recorder.

10. The method of claim 7, wherein the step of rotating the optical disc rotates the optical disc at constant angular velocity.
